(19) United States
(12) Patent Application Publication
(10) Pub. No.: US 2015/0161471 A1
(43) Pub. Date: Jun. 11, 2015

(54) METHOD FOR FITTING A STRAIGHT LINE TO DATA WITH OUTLIERS

(71) Applicant: INDIAN INSTITUTE OF TECHNOLOGY, BOMBAY, Mumbai (IN)

(72) Inventors: Paluri Satya Vydeeswara NATARAJ, Mumbai (IN); Chintankumar K. MODI, Petlad (IN)

(73) Assignee: INDIAN INSTITUTE OF TECHNOLOGY, BOMBAY, Mumbai (IN)

(21) Appl. No.: 14/102,975

(22) Filed: Dec. 11, 2013

(51) Int. Cl. G06K 9/52; G06T 7/60

(52) U.S. Cl. CPC G06K 9/52; G06T 7/60

(57) ABSTRACT

A method for fitting a straight line for a statistics dataset (x, y) containing outliers comprising the steps of: a) receiving a statistics dataset (x, y) containing outliers; b) constructing initial interval search box [m,c] for slope and intercept for received statistics dataset (x, y); c) formulating an objective function based on initial search box; d) obtaining an equation of line model by representing it in interval domain; e) processing interval residuals by taking the difference between response variable and estimation of response variable in interval domain; f) evaluating interval Tukey's biweight function by deciding the outlierness of any data point by comparing the robust median of absolute deviation of interval residuals and absolute value of interval residual for that point; g) finding the estimates of slope and intercept by using vectorized version of interval global optimization process; and h) fitting a straight line for the statistics dataset (x, y) based on the estimates of slope and intercept.

### FIELD OF THE INVENTION

The present invention relates to a method for fitting a straight line to data with outliers, and, more particularly to determine the inclination or side or pitch or gradient or slope and intercept value of statistics data with outliers, to identify abnormal behavior in statistics data and a systematic way to reject “atypical” observations from statistics data.

### BACKGROUND OF THE INVENTION

Many robust parameter estimation techniques are available to process any statistics data having abnormal behaviour data points. These “atypical” data points or the outliers need to be rejected while evaluating the data set's general trend in terms of finding or determining its inclination or side or pitch or gradient or slope. Usually, M-estimator (maximum likelihood type estimator), L-estimator (linear combinations of order statistics), R-estimator (estimator based on rank transformation), Repeated Median (RM) estimator, Least Square estimator (LS) or Least Trimmed Squares (LTS) estimator and Least Median of Squares (LMS) estimator are used to achieve this task.

There are computational difficulties associated with the M-estimator. Firstly, the M-estimator is not robust to the initialization; the choice of the initial estimate has a significant influence on the quality of the M-estimate. This is a problem common to nonlinear regression procedures. It is due to the reason that the M-estimate is defined as the global minimum of a non-convex energy function. Commonly used gradient based algorithms can get stuck at non-global solutions. Secondly, the processes are dependent on some scale estimate, such as the Median of Absolute Deviation (MAD). There are free parameters which, together with the scale estimate, determine the threshold for rejection of outliers and have to be chosen on some basis. Also the selection of weighting function plays a vital role in robustness of the estimation. Thirdly, the convergence of the iterative processes is not guaranteed. If the process does converge, the solution might not be a global solution. Owing to the above problems, the theoretical breakdown point can hardly be achieved.

The essential form of the M-estimator problem is the following:

Having an input data set (x, y) of n data samples having outliers, a line model is assumed as

y=mx+c (1)

where m=slope and c=intercept

Let ηᵢ be the residual of the i^{th} datum, the difference between the i^{th} observation and its fitted value i.e. ηᵢ=yᵢ−ŷᵢ, where, ŷᵢ=\hat{m}xᵢ+ĉ.

where, yᵢ=i^{th} input or dependent/response variable, ŷᵢ=estimate of i^{th} response variable, ηᵢ=residuals/errors

The standard least-squares process tries to minimize

$${\sum }_{i} {η}_{i}^{2} ,$$

which is unstable if there are outliers present in the data. Outlying data give an effect so strong in the minimization that the parameters thus estimated are distorted. The M-estimators try to reduce the effect of outliers by replacing the squared residuals ηᵢ² by another function of the residuals, yielding

$$min {\sum }_{i} ρ ( \frac{{η}_{i}}{\hat{σ}} ) \qquad ( 2 )$$

where ρ(.)=robust M estimating function and \hat{σ}=robust scale estimate.
where, ρ(.) is a symmetric, positive-definite function with a unique minimum at zero, and is chosen to be less increasing than square. If ρ(.) is differentiable, differentiating equation (2)

$${\sum }_{i} {ρ}^{′} ( \frac{{η}_{i}}{\hat{σ}} ) = {\sum }_{i} ψ ( \frac{{η}_{i}}{\hat{σ}} ) = 0 \qquad ( 3 )$$

where, ψ(.)=derivative of estimating function

Solutions of equation (3) are the M estimates of m and c. Equation (3) can be represented in the form of weighting function as

$${\sum }_{i} 2 {η}_{i} h ( \frac{{η}_{i}}{\hat{σ}} ) = 0 \qquad ( 4 )$$

Where, h(.)=derivative of ψ(.) function
Problems to be addressed in M estimation are:
(1) Choosing an appropriate ρ(.) or ψ(.)
(2) Choosing an appropriate measure of scale parameter \hat{σ}.
(3) Finding a process for estimation.

When both x and y contains outliers then bounded ρ(.) function or bounded ψ(.) function is best. “Redescending” ψ(.) functions offer an increase in robustness toward large outliers. Tukey's and Andrew's functions are of redescending type. Selecting Tukey's ρ(.) given by

$$\begin{matrix}ρ ( \frac{{η}_{i}}{\hat{σ}} ) = \{ \begin{matrix}( 1 \text{/} 6 ) [ 1 - {[ 1 - {( \frac{{η}_{i}}{k \hat{σ}} )}^{2} ]}^{3} ] , & if \vert {η}_{i} \vert \leq k \hat{σ} \\ 1 \text{/} 6 , & if \vert {η}_{i} \vert > k \hat{σ}\end{matrix} & ( 5 ) \\ {ρ}^{′} ( \frac{{η}_{i}}{\hat{σ}} ) = 6 ψ ( \frac{{η}_{i}}{\hat{σ}} ) \text{/} {k}^{2} & ( 6 ) \\ ψ ( \frac{{η}_{i}}{\hat{σ}} ) = \{ \begin{matrix}{{η}_{i} [ 1 - {( \frac{{η}_{i}}{k \hat{σ}} )}^{2} ]}^{2} , & if \vert {η}_{i} \vert \leq k \hat{σ} \\ 0 , & if \vert {η}_{i} \vert > k \hat{σ}\end{matrix} & ( 7 ) \\ h ( \frac{{η}_{i}}{\hat{σ}} ) = \{ \begin{matrix}{[ 1 - {( \frac{{η}_{i}}{k \hat{σ}} )}^{2} ]}^{2} , & if \vert {η}_{i} \vert \leq k \hat{σ} \\ 0 , & if \vert {η}_{i} \vert > k \hat{σ}\end{matrix} & ( 8 )\end{matrix}$$

where, h(.)=ψ′(.)=Weighting function and k=tuning constant.
R. A. Marona, R. D. Martin and V. J. Yohai, “Robust Statistics: Theory and Methods”, 2006, John Wiley & Sons, p 126 teaches that the Median Absolute Deviation (MAD) has emerged as the most useful ancillary estimate of scale. It is defined as the median (med) of the absolute deviations from the median;

MAD(η)=med{|ηᵢ−M|}, where, M=med{ηᵢ} (9)

A roughly unbiased estimate of the standard deviation residuals with the normal distribution for large sample size is

$$\hat{σ} = \frac{M A D ( η )}{0.6745} \qquad ( 10 )$$

The choice of tuning constant, k involves a trade-off between efficiency and robustness. The default value of k is 4.6850. There are strong heuristic arguments in favour of using studentized residuals to adjust the residuals ηᵢ by computing

$$\frac{{η}_{i}}{sqrt ( 1 - b )} ,$$

where b is the vector of leverage values from a least squares fit.

One could use any of the general processes for solving equations in (3) such as Newton-Raphson algorithm, but processes based on derivatives may be unsafe with the bounded ρ(.) function or bounded ψ(.) function. Equation (3) is solved using an iterative process known as “Iteratively Reweighted Least Squares (IRLS)”. In which the estimation involves the following steps:

1. Start with robust initial estimates of m, c and robust scale estimate, \hat{σ}
2. Compute the residuals (ηᵢ), adjust them using studentized method.
4. Compute weights for each data points using Tukey's biweight function given by equation (8)
5. Update the estimates \hat{m} and ĉ, using Weighted Least Squares (WLS)
6. Repeat 2.-5. until convergence i.e. |ηᵢ|≦ε where ε is a small number

If ψ(.) function is redescending, some solutions of equation (3) (usually called bad solutions) may not correspond to the absolute minimum of the criterion, which defines the M estimates (equation (2)). Equation (3) may have multiple solutions corresponding to multiple “local” minima of equation (2). The iterative processes like IRLS, may converge to a local minima and might not converge to a global minima. Therefore a process which gives accurate estimates of m and c, converging to a global minimum is highly desirable.

The present invention is contrived in consideration of the circumstances mentioned hereinbefore, and is intended to compute regression coefficient robustly to data with outliers, to compute global optimum values of slope/s and intercept from a generally non convex optimization problem based on robust M estimation using Tukey's biweight M estimation function or using any type of M estimation function or using any type of redescending M estimation function or using any type of monotone M estimation function thereby providing a method for fitting a straight line to data with outliers, identifying abnormal behavior in statistics data and a systematic way to reject “atypical” observations from statistics data.

### SUMMARY OF THE INVENTION

A method for fitting a straight line for a statistics dataset (x, y) containing outliers comprising the steps of: a) receiving a statistics dataset (x, y) containing outliers; b) constructing initial interval search box [m,c] for slope and intercept for received statistics dataset (x, y); c) formulating an objective function based on initial search box; d) obtaining an equation of line model by representing it in interval domain; e) processing interval residuals by taking the difference between response variable and estimation of response variable in interval domain; f) evaluating interval Tukey's biweight function by deciding the outlierness of any data point by comparing the robust median of absolute deviation of interval residuals and absolute value of interval residual for that point; g) finding the estimates of slope and intercept by using vectorized version of interval global optimization process; and h) fitting a straight line for the statistics dataset (x, y) based on the estimates of slope and intercept.

### BRIEF DESCRIPTION OF THE DRAWINGS

The above-mentioned and other features and advantages of the various embodiments of the invention, and the manner of attaining them, will become more apparent and better understood by reference to the accompanying drawings, wherein:

FIG. 1 is the pictorial representation of the hardware components such as input unit, output unit and central processing involved in the present invention

FIG. 2 is the graphical representation of lines fitted using various conventional processes according to Example 1

FIG. 3 is the graphical representation of resultant lines using invented VIGO-RM process vs. conventional processes according to Example 1

FIG. 4 is the graphical representation of lines fitted using various conventional processes according to Example 2

FIG. 5 is the graphical representation of resultant lines using invented VIGO-RM process vs. conventional processes according to Example 2

FIG. 6 is the graphical representation of lines fitted using various conventional processes according to Example 3

FIG. 7 is the graphical representation of resultant lines using invented VIGO-RM process vs. conventional processes according to Example 3

### DETAILED DESCRIPTION OF THE INVENTION

The invention may be better understood and further advantages and uses thereof more readily apparent when considered in view of the following detailed description of exemplary embodiments, taken with the accompanying figures. These embodiments describe only a few of the various ways in which the principles of various other embodiments may be realized and the described embodiments are intended to include all such embodiments and their equivalents and the reference numerals used in the accompanying drawings correspond to the like elements throughout the description.

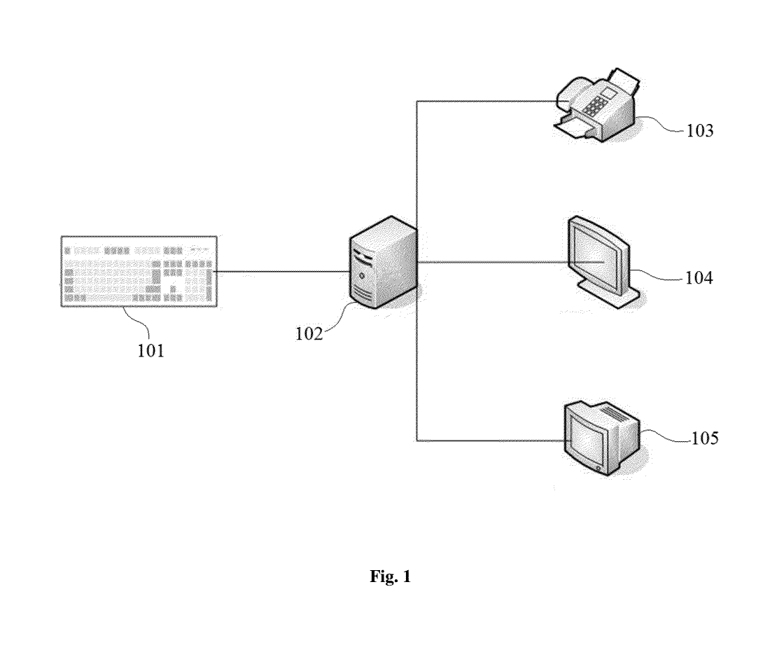

Referring to FIG. 1, statistics experiments data needs to be given as input to the central processing unit 102 using input devices like keyboard 101 and processing will be done using a computational device like any central processing unit 102. The output viz. the inclination or side or pitch or gradient or slope and intercept value of statistics data with outliers and information about “atypical” observations will be displayed on any display device 103; 104; 105. It is understood that display device 103 is a printer, 104 is a LCD monitor and 105 is a CRT monitor. In the central processing unit 102 the unconstrained global optimization problem of equation (2) can be formulated as an interval global optimization problem.

$$\begin{matrix}min {\sum }_{i} ρ ( \frac{{η}_{i}}{k \hat{σ}} ) & ( 11 ) \\ {y}_{i} = {mx}_{i} + c & ( 12 ) \\ {η}_{i} = {y}_{i} = {y}_{i} & ( 13 )\end{matrix}$$

where. ηᵢ represents the interval residual errors, \hat{σ} is a robust estimate of spread computed using equation (10), and m=interval inclination or side or pitch or gradient or slope, c=interval intercept.

Here,

$${\sum }_{i} ρ ( \frac{{η}_{i}}{k \hat{σ}} )$$

is natural interval extension of

$${\sum }_{i} ρ ( \frac{{η}_{i}}{ \hat{σ}} ) .$$

We call this function a natural interval extension ƒ_{NIE} of real domain function ƒ. Further we optimize this natural interval extension function to obtain the values of slope and intercept.

The interval representation of Tukey's function given in equation (5) will be

$$ρ ( \frac{{η}_{i}}{ k \hat{σ}} ) = \{ \begin{matrix}( 1 \text{/} 6 ) [ 1 - {[ 1 - {( \frac{{η}_{i}}{k \hat{σ}} )}^{2} ]}^{3} ] , & if \vert {η}_{i} \vert \leq k \hat{σ} \\ 1 \text{/} 6 , & if \vert {η}_{i} \vert > k \hat{σ}\end{matrix} \qquad ( 14 )$$

The evaluation of equation (14) comprises of comparison of absolute interval residuals with the robust median of absolute deviation of residuals. If the absolute of interval residual ηᵢ for an i^{th} datum is greater than k\hat{σ} then that data point will be treated as an outlier and hence will be assigned the value of ⅙. In contrast if the absolute of interval residual ηᵢ for an i^{th} datum is less than or equal to k\hat{σ} then that data point will be treated as an inlier and hence will be assigned an interval value evaluated as per equation (14). The interval process taught in R. E. Moore, “Methods and Applications of Interval Analysis”, Philadelphia: SIAM, 1979 as the unconstrained global optimization procedure of interval processes utilize interval arithmetic to get an upper and lower bound around the global minimum. The global minimum is found by partitioning the search space into regions, where, in every iterations, regions are selected for further search by additional partitioning. A major attribute of interval processes is their ability to find the global minimum of highly complex differentiable or non differentiable objective functions.

In the basic process described above, in each iteration only the leading box from the list of boxes is processed. However, the process of the present invention uses Vectorized Interval Global Optimization (VIGO) as taught in P. S. V. Nataraj, A. K. Prakash and Nandkishor Kubal, “An Efficient Algorithm for Unconstrained Global Optimization using interval analysis, Proceedings of the 6^{th} International Conference on High Performance Computing in Asia Pacific region, Dec. 16-19, 2002, Bangalore, India, in which all boxes from the list of boxes are processed simultaneously. Also to perform function and gradient evaluations, midpoint test, width checks and bisections on all boxes in an iteration, the present invention uses vectorized interval arithmetic operations.

The steps of the process of invention of finding global minima of objective function given in equation (11) are listed below:

Inputs: Statistics experimental data set (x, y). The initial search range (box) v = [m, c], a natural
interval extension f_{NIE} for f:v → [symbol] , and accuracy parameter ε_{F}.
Outputs: Final inclination or slope or gradient or side or pitch value and intercept value (\hat{m}, ĉ ).
BEGIN Process

| | |
|---|---|
| 1. | Construct interval search box v = [m, c]. |
| 2. | Compute ηᵢ and \hat{σ} using equations (12) and (11) respectively. |
| 3. | Set v₁ = [m, c], Calculate f_{NIE}(v₁), and set v₁ = inf f_{NIE}(v₁). Next, initialize list L = ((v₁, v₁)) |
| | and the cut-off value t = f (mid (v₁)). |
| 4. | Set lᵣ as the length of L. Then, choose a coordinate direction kₙ parallel to which vₙ has |
| | an edge of maximum length, n = 1, 2, . . . , lᵣ. |
| 5. | Bisect vₙ in direction of kₙ getting boxes vₙ¹ and vₙ², here vₙ = vₙ¹∪vₙ², n = 1, 2, . . . , lᵣ. |
| 6. | Calculate f_{NIE} (vₙ¹) and f_{NIE} (vₙ²) and set vₙⁱ = inf{f_{NIE}(vₙⁱ)}, for i = 1, 2 and n = 1, 2, . . . , lᵣ. |
| 7. | Discard the pair (vₙⁱ, vₙⁱ) if vₙⁱ > t , where, iε {1, 2}, nε{1, 2, . . . , lᵣ}. |
| 8. | Delete all items from L, and enter the remaining pair(s) of above step in L. Set l_{r′} as the |
| | (temporary) length of L. If l_{r′} is zero, then EXIT. Otherwise, arrange L such that the |
| | second members of all pairs of L do not decrease. |
| 9. | Update the cut-off value as t = min{t, f(mid(v₁)), . . . , f(mid(vₗ^{_{r′}}))} |
| 10. | (Cut-off test) Discard from L all pairs whose second members are greater than the cut-off |
| | value t. |
| 11. | Terminate if w(f_{NIE})(v₁)) ≦ ε_{F}. |
| 12. | Go to Step 4. |

END Process

The developed Vectorized or parallel version of the interval global optimization based robust M estimation process (VIGO-RM) converges very fast to the final inclination or slope or gradient or side or pitch value and intercept value.

The following examples are illustrative of the invention but not limitative of the scope thereof.

### Example 1

Consider an example of an anticoagulant drug formulation which is a subject of a drug response study [James E. De Muth, New York, Marcel Dekker, “Basic Statistics and Pharmaceutical Statistical Applications (Biostatistics (New York, N.Y.), 2)”, Table 13.3, pp: 349-340]. Twelve healthy male volunteers received a single dose of various strengths of an experimental anticoagulant. The data is given in Table 1. Given these data, the problem is to determine the relationship between the dosage (x) in mg and corresponding prothrombin time (y) in seconds.

TABLE 1
Formulation of an anticoagulant

| Dosage, | Prothrombin | Dosage, | Prothrombin |
|---|---|---|---|
| x (mg) | time, y (sec) | x (mg) | time, y (sec) |
| 200 | 20 | 220 | 19 |
| 180 | 18 | 175 | 17 |
| 225 | 20 | 215 | 20 |
| 205 | 19 | 185 | 19 |
| 190 | 19 | 210 | 19 |
| 195 | 18 | 230 | 20 |

In the present example, it is assumed that dosage and prothrombin time are truly linearly related: y=mx+c, where, y=prothrombin time; c=prothrombin time at zero dosage; m=rate constant and x=drug dosage in mg.

The existing Iteratively Reweighted Least Square (IRLS) process is applied to find the slope and intercept of the dataset. The tuning constant k is taken as a default value of 4.6850 and the fixed value of robust scale \hat{σ} calculated using equation (10) is 0.8045. The estimates of slope and intercept are given in Table 2 along with the estimates computed using different implementations of M-estimates using various functions like robustfit and rlm of different standard softwares like MATLAB 7.5, R 2.7.1 (freeware), S-PLUS 8.0 (student version).

TABLE 2
Estimated values of Slope and Intercept using different processes

| | Estimate of | Estimate | Optimization | % Reduction |
|---|---|---|---|---|
| Process | Intercept | of Slope | function | in function |
| (Software, function) | (ĉ/ĉ) | (\hat{m}/\hat{m}) | value | value |
| VIGO-RM | [9.2916, | [0.0470, | [0.0002862, | |
| | 9.2917] | 0.0470] | 0.0002951] | |
| Least Square (LS) | 10.7867 | 0.0406 | 0.0003581 | 18.8384 |
| (MATLAB | | | | |
| 7.5, regress) | | | | |
| IRLS (MATLAB | 10.8737 | 0.0401 | 0.0003559 | 18.3528 |
| 7.5, robustfit) | | | | |
| IRLS (R 2.7.1, rlm) | 10.8271 | 0.0403 | 0.0003536 | 17.8001 |
| IRLS (SPLUS 8.0, rlm) | 10.8271 | 0.0403 | 0.0003536 | 17.7997 |

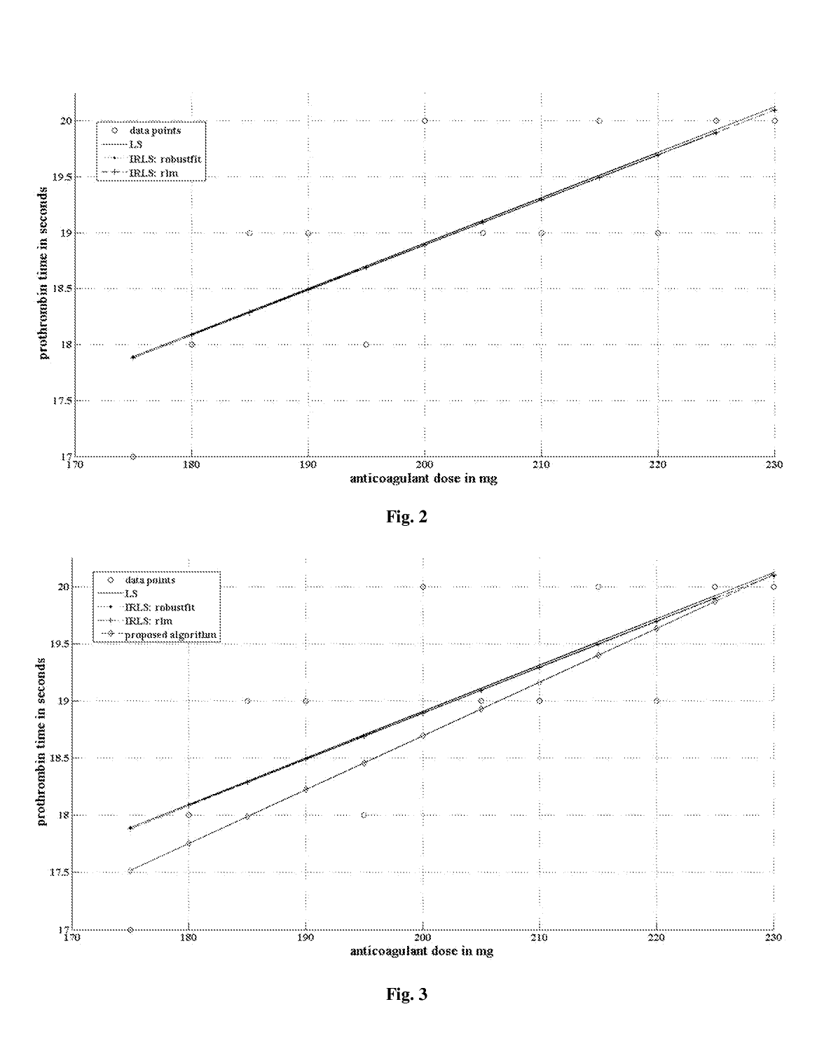

The lines fitted using various estimates of slope and intercept are plotted in FIG. 2. For a dose of 100 mg, if we determine the prothrombin time using the estimates given by various implementations then we get 14.8466 and 14.8836 seconds for LS and IRLS respectively.

Next, the process of the invention, VIGO-RM, is applied to determine the intercept and slope for the same data set. The search region is set to m=[0.01, 0.06] and c=[7, 13]. The tuning constant is taken again as a default value of 4.6850 and the fixed value of robust scale \hat{σ} calculated using equation (10) is 0.8045. The process of invention is applied to obtain the global minimum values of slope \hat{m} and intercept ĉ. The convergence accuracy of 1e^{-0.5} is achieved in 28.8 seconds with 704856 function calls. The estimated interval slope and intercept are given in Table 2. The midpoint values of estimates are ĉ=mid(ĉ)=9.2917 and \hat{m}=mid(\hat{m})=0.04703. For a dose of 100 mg, if we determine the prothrombin time using the estimates given by VIGO-RM process then we get the prothrombin time equal to 13.9928 seconds, which is significantly different compared to other processes' times. Note that compared to the IRLS process, the process of invention finds energy/cost function's global minimum value as listed in Table 2. Even the percentage reduction in the cost function value is quiet high compared to all other processes of regression. Considering the range of response variable from 10 to 20 seconds, for the independent variable's range of 100 mg to 230 mg, the difference of 0.8812 seconds is large. The line fitted by using the process of invention is plotted in FIG. 3.

### Example 2

Consider an example of physiological data analysis [Martin Bland, Oxford University Press, 2000, “Introduction to Medical Statistics, 3^{rd} Edition”, Table 11.1, pp: 186]. A group of medical students collected data of Forced expiratory volume in one second (FEV1) and height of twenty male medical students. The data is given in Table 3. Given these data, the problem is to determine the relationship between the Forced expiratory volume in one second (FEV1) (y) in litres and height (x) in cm.

TABLE 3
Data for physiological analysis

| Height, x | FEV1, y | Height, x | FEV1, y |
|---|---|---|---|
| (cm) | (litres) | (cm) | (litres) |
| 164.0 | 3.54 | 177.0 | 4.05 |
| 167.0 | 3.54 | 177.0 | 5.43 |
| 170.4 | 3.19 | 177.4 | 3.60 |
| 171.2 | 2.85 | 178.0 | 2.98 |
| 171.2 | 3.42 | 180.7 | 4.80 |
| 171.3 | 3.20 | 181.0 | 3.96 |
| 172.0 | 3.60 | 183.1 | 4.78 |
| 172.0 | 3.78 | 183.6 | 4.56 |
| 174.0 | 4.32 | 183.7 | 4.68 |
| 176.0 | 3.75 | 177.0 | 4.05 |
| 177.0 | 3.09 | 177.0 | 5.43 |

In the present case, we will assume that FEV1 and height are truly linearly related: y=mx+c, where, y=FEV1 in litres; c=FEV1 at zero height; m=rate constant; and x=height in cm.

The existing IRLS process is applied to determine the slope and intercept of the dataset. The tuning constant k is taken as a default value of 4.6850 and the fixed value of robust scale \hat{σ} calculated using equation (11) is 0.5445. The estimates of slope and intercept are given in Table 4 along with the estimates determined using different implementations of M-estimates using various functions like robustfit and rlm of different standard softwares like MATLAB 7.5, R 2.7.1 (freeware), S-PLUS 8.0 (student version).

TABLE 4
Estimated values of Slope and Intercept using different processes

| | Estimate of | Estimate | Optimization | % Reduction |
|---|---|---|---|---|
| Process | Intercept | of Slope | function | in function |
| (Software, function) | (ĉ/ĉ) | (\hat{m}/\hat{m}) | value | value |
| VIGO-RM | [−6.4002, | [0.0594, | [0.0001340, | |
| | −6.4000] | 0.0595] | 0.0001429] | |
| LS (MATLAB | −9.1904 | 0.0744 | 0.0001981 | 30.0566 |
| 7.5, regress) | | | | |
| IRLS (MATLAB | −9.1757 | 0.0742 | 0.0002066 | 32.9513 |
| 7.5, robustfit) | | | | |
| IRLS (R 2.7.1, rlm) | −9.1180 | 0.0738 | 0.0002071 | 33.1014 |
| IRLS (SPLUS 8.0, rlm) | −9.1180 | 0.0738 | 0.0002071 | 33.1014 |

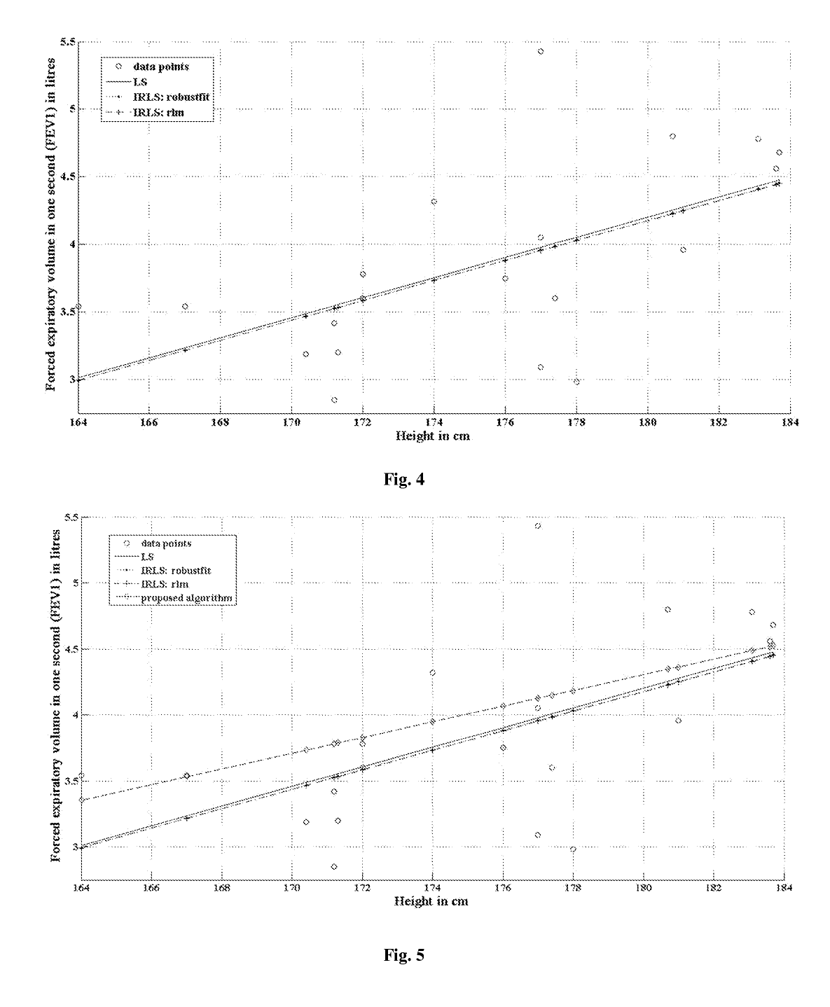

The lines fitted using various estimates of slope and intercept are plotted in FIG. 4. For a height of 164 cm, if we determine the FEV1 values using the estimates given by various processes then we get 3.0112 and 2.9931 liters for LS and IRLS processes respectively.

Next, the process of invention, VIGO-RM, is applied to determine the intercept and slope for the same data set. The search region is set to m=[0.05,0.15] and c=[−6,−15.5]. The tuning constant is taken again as a default value of 4.6850 and the fixed value of robust scale \hat{σ} calculated using equation (10) is 0.5445. The process of invention is applied to obtain the global minimum values of slope \hat{m} and intercept ĉ. The convergence accuracy of 1e^{-0.5} is achieved in 29.8 seconds in 471066 function calls. The estimated interval slope and intercept are given in Table 4. The midpoint values of estimates are ĉ=mid(ĉ)=−6.4001 and \hat{m}=mid(\hat{m})=0.0595. For a height of 164 cm, if we determine the FEV1 value using the estimates given by VIGO-RM process then we get the FEV1 value equal to 3.3533 liters, which is significantly different compared to other processes' FEV1 values. Note that compared to IRLS process, the process of invention finds energy/cost function's global minimum value as listed in Table 4. Even the percentage reduction in the cost function value is quiet high compared to all other processes of regression. Considering the range of response variable from 2 to 5 litres, for the independent variable's range of 150 cm to 200 cm, the difference of 0.36 litres is very large. The line fitted by using the process of invention is plotted in FIG. 5.

### Example 3

Consider an example of dose response analysis [Samprit Chatterjee and Ali S. Hadi, “Regression Analysis by Example, 2006, 4^{th} Edition, John Wiley & Sons, Table 6.2, pp: 129]. The data given in Table 5 represents the number of surviving bacteria (in hundreds) as estimated by plate counts in an experiment with marine bacterium following exposure to 200-kilovolt X-rays for periods ranging from t=1 to 15 intervals of 6 minutes. The response variable y represents the number surviving after exposure time t. The experiment came out to test the single-hit hypothesis of X-ray action under constant field of radiation. According to this theory, there is a single vital centre in each bacterium, and this must be hit by a ray before the bacteria is inactivated or killed. The particular bacterium study does not form clumps or chains, so the number of bacterium can be estimated directly from plate counts.

TABLE 5
Bacteria deaths due to X-Rays variation

| Exposure | Number of | Exposure | Number of | Exposure | Number of |
|---|---|---|---|---|---|
| interval, x | Surviving | interval, x | Surviving | interval, x | Surviving |
| (6 minutes | Bacteria, y | (6 minutes | Bacteria , y | (6 minutes | Bacteria , y |
| interval) | (hundreds) | interval) | (hundreds) | interval) | (hundreds) |
| 1 | 355 | 6 | 106 | 11 | 36 |
| 2 | 211 | 7 | 104 | 12 | 32 |
| 3 | 197 | 8 | 60 | 13 | 21 |
| 4 | 166 | 9 | 56 | 14 | 19 |
| 5 | 142 | 10 | 38 | 15 | 15 |

Although the data set is suitable for exponential model fit, in the present case, we will assume that the survival numbers and the time intervals are truly linearly related:

y=mx+c, where, y=number of surviving bacteria in hundreds; c=number of surviving bacteria when exposure time is zero; m=rate constant; and x=exposure interval.

The existing IRLS process is applied to determine the slope and intercept of the dataset. The tuning constant k is taken as a default value of 4.6850 and the fixed value of robust scale \hat{σ} calculated using equation (10) is 36.6499. The estimates of slope and intercept are given in Table 6 along with the estimates determined using different implementations of M-estimate using various functions like robustfit and rlm of different standard softwares like MATLAB 7.5, R 2.7.1 (freeware), S-PLUS 8.0 (student version).

TABLE 6
Estimated values of Slope and Intercept using different processes

| | Estimate of | Estimate | Optimization | % Reduction |
|---|---|---|---|---|
| Process | Intercept | of Slope | function | in function |
| (Software, function) | (ĉ/ĉ) | (\hat{m}/\hat{m}) | value | value |
| VIGO−RM | [298.7397, | [−0.2075, | [0.000784, | |
| | 298.7401] | −0.2075] | 0.000784] | |
| LS (MATLAB | 259.5810 | −19.4643 | 0.001092 | 28.2626 |
| 7.5, regress) | | | | |
| IRLS (MATLAB | 219.4486 | −15.7115 | 0.001583 | 50.4820 |
| 7.5, robustfit) | | | | |
| IRLS (R 2.7.1, rlm) | 219.5582 | −15.7148 | 0.001580 | 50.4019 |
| IRLS (SPLUS | 219.5582 | −15.7148 | 0.001580 | 50.4019 |
| 8.0, rlm) | | | | |

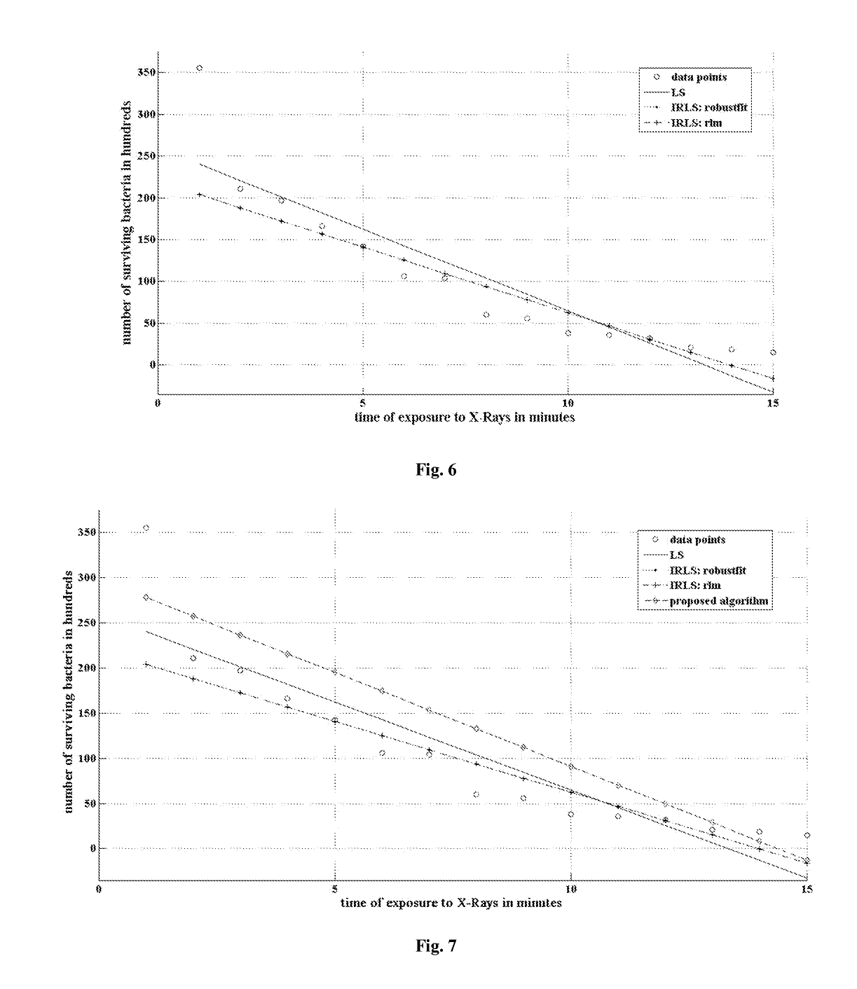

The lines fitted using various estimates of slope and intercept are plotted in FIG. 6. For time interval of 1 (i.e. 6 minutes), if we determine the number of surviving bacteria using the estimates given by various processes then we get 240.1160 and 203.7371 hundred for LS and IRLS processes respectively.

Next, the process of invention, VIGO-RM, is applied to determine the intercept and slope for the same data set. The search region is set to m=[−5,−22] and c=[100,320]. The tuning constant is taken again as a default value of 4.6850 and the fixed value of robust scale \hat{σ} calculated using equation (10) is 36.6499. The process of invention is applied to obtain the global minimum values of slope \hat{m} and intercept ĉ. The convergence accuracy of 1e^{-0.5} is achieved in 62.7 seconds with 1413386 function calls. The estimated interval slope and intercept are given in Table 6. The midpoint values of estimates are ĉ=mid(ĉ)=298.7399 and \hat{m}=mid(\hat{m})=−0.2075. For time interval of 1 (i.e. 6 minutes), if we determine the number of surviving bacteria using the estimates given by VIGO-RM process then we get the number of surviving bacteria equal to 277.9807 hundred, which is significantly different compared to other processes' times. Note that compared to the IRLS process, the process of invention finds energy/cost function's global minimum value as listed in Table 6. Even the percentage reduction in the cost function value is quiet high compared to all other processes of regression. Considering the range of response variable from 50 hundred to 400 hundred, for the independent variable's range of 1 to 15, the difference of 77 hundred is quiet large. The line fitted by using the process of invention is plotted in FIG. 7.

It is clear from the resultant lines for all examples that when the slope and intercept values are determined and displayed using the process of the invention, the global minima is achieved which is not achieved by any other process. The process according to present invention produces solution results that are reliable and accurate. These features follow from the use of interval analysis tools that account for rounding errors which can occur on any central processing unit. Furthermore, the process according to present invention removes any outliers available in the data points, by evaluation of interval Tukey's biweight function which is a redescending type of function for which the iterative processes like IRLS does not converge to a global minimum.

Accordingly, the present invention provides a procedure to evaluate global optimum values of slope/s and/or intercept from a generally non convex optimization problem based on robust M estimation using any type of redescending M estimation function or using any type of monotone M estimation function or using any type of M estimation function.

Furthermore, the present invention removes the need of good initial estimate which is very crucial for any other robust regression algorithm and also removes the “uniqueness problem” caused by iterative algorithms like IRLS. As evident from the preceding discussions and example, the present invention computes guaranteed true results.

The particular embodiments disclosed above are illustrative only, as the invention may be modified and practiced in different but equivalent manners apparent to those skilled in the art having the benefit of the teachings herein. Furthermore, no limitations are intended to the details of process herein described, other than as described in the claims below. Accordingly, the protection sought herein is as set forth in the claims below. Although the present invention is shown in a limited number of forms, it is not limited to just these forms, but is amenable to various changes and modifications.

1. A method for fitting a straight line for a statistics dataset (x, y) containing outliers comprising the steps of:
a) receiving a statistics dataset (x, y) containing outliers;
b) constructing initial interval search box [m,c] for slope and intercept for received statistics dataset (x, y);
c) formulating an objective function based on initial search box;
d) obtaining an equation of line model by representing it in interval domain;
e) processing interval residuals by taking the difference between response variable and estimation of response variable in interval domain;
f) evaluating interval Tukey's biweight function by deciding the outlierness of any data point by comparing the robust median of absolute deviation of interval residuals and absolute value of interval residual for that point;
g) finding the estimates of slope and intercept by using vectorized version of interval global optimization process; and
h) fitting a straight line for the statistics dataset (x, y) based on the estimates of slope and intercept.

2. A method as claimed in claim 1, wherein the initial search box [m,c] is constructed by assigning sufficiently large neighborhoods to the parameters values found using Least Square estimator or Least Trimmed Squares estimator or Least Median of Squares estimator.

3. A method as claimed in claim 1, wherein the objective function obtained for intercept and slope is evaluated using interval global optimization technique.

4. A method as claimed in claim 1, wherein the objective function obtained for intercept and slope is evaluated using vectorized version of interval global optimization technique.

5. A method as claimed in claim 1, wherein the outlierness of any data point is identified by comparing the robust median of absolute deviation of residuals and absolute value of interval residual for that point.
